(19) United States
(12) Patent Application Publication
(10) Pub. No.: US 2012/0001601 A1
(43) Pub. Date: Jan. 5, 2012

(54) POWER SUPPLY SYSTEM AND POWER SUPPLY METHOD

(76) Inventor: Tadahiro Motoyama, Kanagawa (JP)

(21) Appl. No.: 13/256,881

(22) PCT Filed: Nov. 12, 2009
(86) PCT No.: PCT/JP2009/006046

§ 371 Date: Sep. 15, 2011

(51) Int. Cl. G05F 1/46

(52) U.S. Cl. 323/234

(57) ABSTRACT

Disclosed is a power supply system capable of achieving low power consumption while reducing CPU control even if the power supply system includes a plurality of regulators. A DCDC (110) and each regulator (120-i (i=1, 2, 3)) have normal modes, and low power consumption modes which operate on lower power consumption than the normal modes as operating current modes, a LINK control unit (130) switches between the operating current modes of the DCDC (110) in accordance with the ON/OFF states of the regulators (120-i), or the operating current modes of the regulators (120-i). As a result, the low power consumption can be achieved while reducing the troublesome CPU control due to a CPU/peripheral LSI (200).

### TECHNICAL FIELD

The present invention relates to a power supply system and a power supply method which supply a stable DC voltage to various electronic apparatuses.

### BACKGROUND ART

In recent years, a CPU (Central Processing Unit) is disposed on a substrate of an electronic apparatus with an enhancement in a performance/function of the electronic apparatus in many cases. Moreover, the CPU is required to carry out a high speed calculation processing. In order to implement the enhancement in the function of the electronic apparatus, furthermore, there is provided a plurality of functional modules or LSIs (Large Scale Integrations) having a function of a television tuner, a WLAN (Wireless Local Area Network) or the like. As compared with the related art, consequently, a current consumption of the electronic apparatus tends to be increased. For this reason, it is an important object to reduce a power consumption of a power supply system for supplying a source voltage to the CPU, the functional module or the LSI. In a wireless communication device such as a portable telephone, particularly, it is necessary to drive the CPU, the functional module or the LSI for a long period of time through a battery. Therefore, the reduction in the power consumption is demanded very highly.

As a method of reducing a power consumption, Patent literature 1 discloses a method of controlling an operating current mode of a DC/DC converter (which will be hereinafter referred to as a DCDC) in a power supply system into a normal mode or a lower consumption mode through a CPU control.

In order to further reduce the power consumption of the power supply system, there is proposed a method of controlling the operating current mode of the DCDC depending on a state of a regulator constituting the power supply system, that is, an ON/OFF state of the regulator or a source current mode.

### CITATION LIST

### Patent Literature

PTL 1

Japanese Patent Application Laid-Open No. 2002-320380

### SUMMARY OF INVENTION

### Technical Problem

In the prior art, however, in the case in which a power supply system includes a plurality of regulators in order to supply a source voltage to a plurality of CPUs, functional blocks or LSIs, the CPUs are to monitor a state of each of the regulators. Consequently, a control by the CPU is complicated so that a great load is applied to the CPU. When the number of the regulators provided in the power supply system is increased, particularly, the CPU control is more complicated.

It is an object of the invention to provide a power supply system and a power supply method which can reduce power consumption while reducing a CPU control also in the case in which the power supply system includes a plurality of regulators.

### Solution to Problem

A power supply system according to the invention employs a structure including a DCDC having, as an operating current mode, a normal mode, and a low power consumption mode in which an operation is carried out with a lower power consumption than in the normal mode, a plurality of regulators having, as an operating current mode, a normal mode, and a low power consumption mode in which an operation is carried out with a lower power consumption than in the normal mode and setting an output from the DCDC as a source voltage, and a control section that switches the operating current mode of the DCDC depending on an ON/OFF state of the plurality of regulators or the operating current mode of the plurality of regulators.

The invention provides a power supply method in a power supply system including a DCDC having, as an operating current mode, a normal mode, and a low power consumption mode in which an operation is carried out with a lower power consumption than in the normal mode, and a plurality of regulators having, as an operating current mode, a normal mode, and a low power consumption mode in which an operation is carried out with a lower power consumption than in the normal mode and setting an output from the DCDC as a source voltage, the method including switching the operating current mode of the DCDC depending on an ON/OFF state of the plurality of regulators or the operating current mode of the plurality of regulators.

### Advantageous Effects of Invention

According to the invention, also in the case in which the power supply system includes the plurality of regulators, it is possible to reduce power consumption while reducing a CPU control.

### BRIEF DESCRIPTION OF DRAWINGS

FIG. 1 is a block diagram showing a structure of a main part in a power supply system according to Embodiment 1 of the invention;

FIG. 2 is a diagram showing a relationship between a transition of an operating current mode in a DCDC and each regulator and each control setting signal according to Embodiment 1;

FIG. 3 is another diagram showing the relationship between the transition of the operating current mode in the DCDC and each regulator and each control setting signal according to Embodiment 1;

FIG. 4 is a further diagram showing the relationship between the transition of the operating current mode in the DCDC and each regulator and each control setting signal according to Embodiment 1;

FIG. 5 is a diagram for explaining a voltage drop in a DCDC output;

FIG. 6 is a block diagram showing a structure of a main part in a power supply system according to Embodiment 2 of the invention;

FIG. 7 is a diagram showing a structure of a main part in a delay unit according to Embodiment 2;

FIG. 8 is a diagram showing an input/output relationship of the delay unit according to Embodiment 2; and

FIG. 9 is a diagram showing a relationship between a transition of an operating current mode of a DCDC and each regulator and each control setting signal according to Embodiment 2.

### DESCRIPTION OF EMBODIMENTS

Embodiments according to the invention will be described below in detail with reference to the drawings.

### Embodiment 1

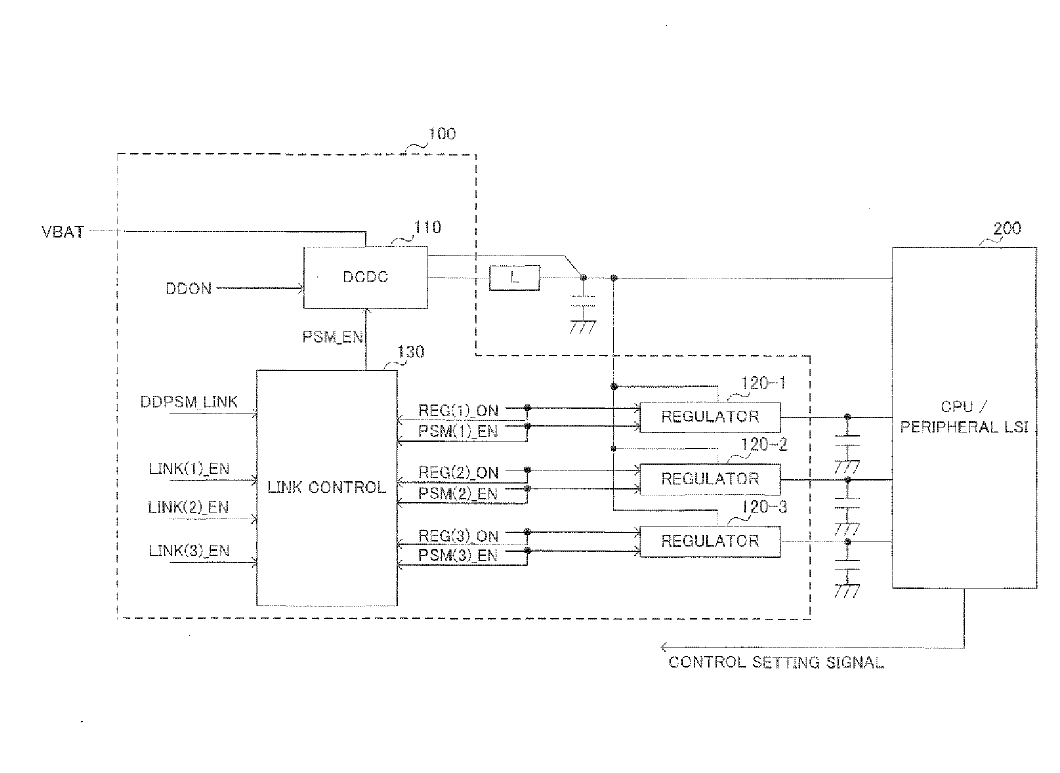

FIG. 1 is a block diagram showing a structure of a main part in a power supply system according to the embodiment. As shown in FIG. 1, power supply system 100 offers a source voltage to CPU/peripheral LSI 200.

DCDC 110 receives as input source voltage VBAT applied from a DC power supply section which is not shown, and outputs source voltage VBAT to regulators 120-1, 120-2 and 120-3. Moreover, DCDC 110 receives as input DCDC starting signal DDON for switching ON/OFF (start/stop) of DCDC 110. DCDC 110 is turned ON if DDON=“1” or “H” is set, and DCDC 110 is turned OFF if DDON=“0” or “L” is set.

Regulators 120-1, 120-2 and 120-3 receive as input a source voltage output from DCDC 110 and regulate a magnitude of the source voltage, and output the source voltage thus regulated to CPU/peripheral LSI 200. Regulators 120-1, 120-2 and 120-3 are constituted by a series regulator, a linear regulator, an LDO (Low DropOut) regulator and the like, for example. Although FIG. 1 shows the case in which power supply system 100 includes three regulators 120-1, 120-2 and 120-3, moreover, the number of the regulators is not limited to three but may be two, four or more.

Regulator 120-i (i=1, 2, 3) receives as input regulator starting signal REG(i)_ON for switching ON/OFF of each regulator. The regulator 120-i is turned ON if REG(i)_ON=“1” or “H” is set, and the regulator 120-i is turned OFF if REG(i)_ON=“0” or “L” is set. Regulator starting signal REG(i)_ON for switching ON/OFF of each regulator is given as a notice from CPU/peripheral LSI 200 to power supply system 100.

Moreover, the regulator 120-i (i=1, 2, 3) receives as input mode switching signal PSM(i)_EN for switching an operating current mode of each regulator. If PSM(i)_EN=“1” or “H” is set, the regulator 120-i is brought into a low consumption mode (Power Save Mode: PSM). On the other hand, if PSM(i)_EN=“0” or “L” is set, the regulator 120-i is brought into a normal mode (Normal Mode: NM).

The low consumption mode (PSM) designates a mode in which only an operational minimum required circuit is operated, resulting in an operation with a lower current consumption as compared with the normal mode, for instance. On the other hand, the normal mode (NM) designates an operating current mode in which a circuit such as a comparator having a large current consumption and an excellent transient characteristic is operated to obtain a more excellent loading capability and transient characteristic of a power supply as compared with the low consumption mode (PSM).

Mode switching signal PSM(i)_EN for switching the operating current mode of each regulator is given as a notice from CPU/peripheral LSI 200 to power supply system 100.

Link control section 130 receives as input regulator starting signal REG(i)_ON and mode switching signal PSM(i)_EN and determines an operating current mode of DCDC 110 depending on the ON/OFF state of each regulator 120-i or the operating current mode of each regulator 120-i. A method of determining the operating current mode of DCDC 110 will be described below.

Link control section 130 outputs, to DCDC 110, mode switching signal PSM_EN for switching the operating current mode of DCDC 110, thereby carrying out switching into an operating current mode that determines the operating current mode of DCDC 110. For example, link control section 130 outputs PSM_EN=“1” or “H” to DCDC 110 if the operating current mode of DCDC 110 is switched into the low consumption mode, and outputs PSM_EN=“0” or “L” to DCDC 110 if the same operating current mode is switched into the normal mode.

Moreover, link control section 130 receives as input control signal DDPSM_LINK and specifying signal LINK(i)_EN (i=1, 2, 3).

Control signal DDPSM_LINK serves to indicate whether or not the operating current mode of DCDC 110 is to be switched depending on the ON/OFF state or the operating current mode of any of the plurality of regulators 120-i (i=1, 2, 3). More specifically, if DDPSM_LINK=“1” or “H” is set, link control section 130 reflects the ON/OFF state or the operating current mode of at least one of regulators 120-i (i=1, 2, 3), thereby determining the operating current mode of DCDC 110. On the other hand, if DDPSM_LINK=“0” or “L” is set, link control section 130 does not reflect the ON/OFF state or the operating current mode of regulator 120-i on the operating current mode of DCDC 110.

Moreover, specifying signal LINK(i)_EN (i=1, 2, 3) serves to specify any of the plurality of regulators 120-i which is to be used in the switching of the operating current mode of DCDC 110. More specifically, if LINK(i)_EN=“1” or “H” is set, link control section 130 reflects the ON/OFF state or the operating current mode of regulator 120-i on the operating current mode of DCDC 110. On the other hand, if LINK(i)_EN=“0” or “L” is set, link control section 130 does not reflect the ON/OFF state or the operating current mode of regulator 120-i on the operating current mode of DCDC 110.

In other words, link control section 130 switches the operating current mode of DCDC 110 depending on only the ON/OFF state of regulator 120-i with LINK(i)_EN=“1” or “H” or the operating current mode of regulator 120-i.

Link control section 130 is constituted by a CMOS (Complementary Metal Oxide Semiconductor) logic circuit or the like, for example.

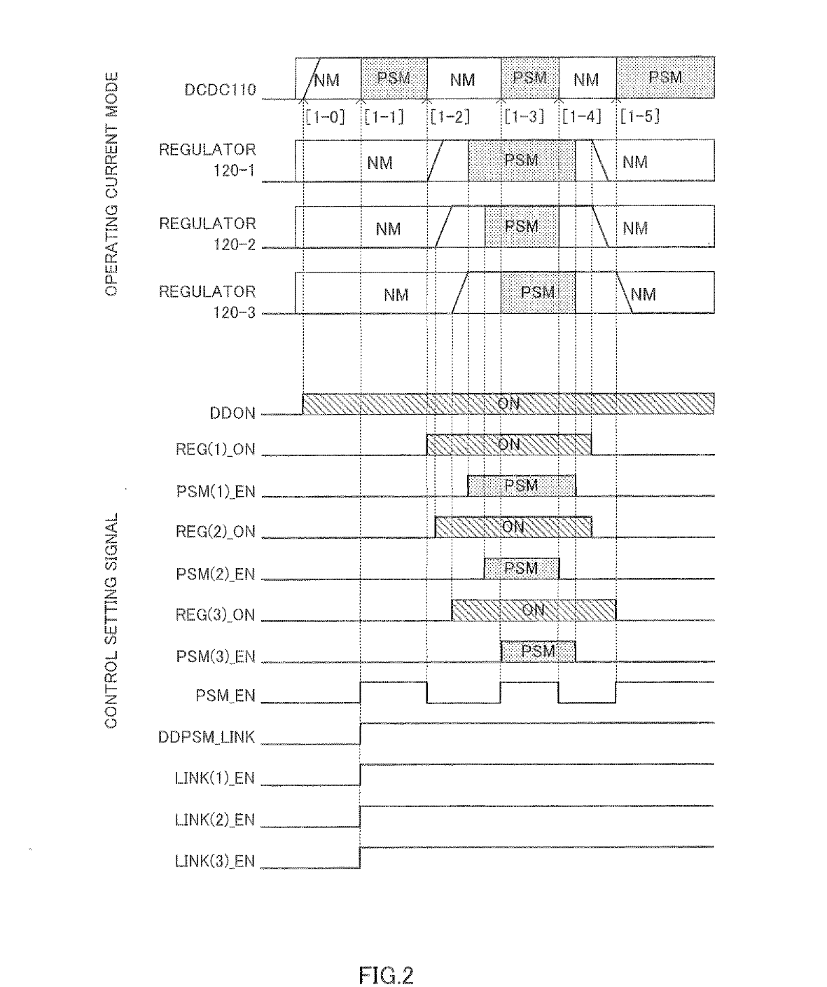

A method of controlling the operating current mode of DCDC 110 according to the embodiment will be described with reference to FIGS. 2, 3 and 4.

FIGS. 2, 3 and 4 are diagrams showing a relationship between a transition of the operating current mode of DCDC 110 and each regulator 120-i (i=1, 2, 3) and each control setting signal. These drawings show, as the control setting signal, DCDC starting signal DDON, regulator starting signal REG(i)_ON (i=1, 2, 3), mode switching signal PSM(i)_EN, mode switching signal PSM_EN, control signal DDPSM_LINK and specifying signal LINK(i)_EN.

The case of DDPSM_LINK=“1” or “H” and LINK(i)_EN=“1” or “H” (i==1, 2, 3)

In this case, the ON/OFF or the operating current mode of all of regulators 120-i (i=1, 2, 3) is reflected on the operating current mode of DCDC 110. Description will be given with reference to FIG. 2.

[1-0]

When DDON=“1” or “H” is input to DCDC 110, DCDC 110 is turned ON.

[1-1]

When DDPSM_LINK=“1” or “H” and LINK(i)_EN=“1” or “H” (i=1, 2, 3) are input to link control section 130 before and after DCDC 110 is started (after starting in the example of FIG. 2), link control section 130 reflects the ON/OFF state or the operating current mode of all of regulators 120-i (i=1, 2, 3) to control the operating current mode of DCDC 110.

More specifically, all of regulators 120-i (i=1, 2, 3) to be a link destination of DCDC 110 are set into the OFF state. Therefore, link control section 130 outputs PSM_EN=“1” or “H” to DCDC 110. Consequently, DCDC 110 makes a transition to PSM.

[1-2]

When regulator starting signal REG(1)_ON=“1” or “H” is input to regulator 120-1, regulator 120-1 is started (ON) in NM. When regulator 120-1 is turned ON if LINK(1)_EN=“1” or “H” is set, link control section 130 outputs PSM_EN=“0” or “L” to DCDC 110. Consequently, DCDC 110 makes a transition to NM.

[1-3]

When all of regulators 120-1, 120-2 and 120-3 make a transition to PSM if LINK(i)_EN=“1” or “H” (i=1, 2, 3) is set, link control section 130 outputs PSM_EN=“1” or “H” to DCDC 110. Consequently, DCDC 110 makes a transition to PSM.

[1-4]

When regulator 120-2 makes a transition from PSM to NM if LINK(2)_EN=“1” or “H” is set, link control section 130 outputs PSM_EN=“0” or “L” to DCDC 110. Consequently, DCDC 110 makes a transition from PSM to NM.

[1-5]

When all of regulators 120-1, 120-2 and 120-3 are turned OFF if LINK(i)_EN=“1” or “H” (i=1, 2, 3) is set, link control section 130 outputs PSM_EN=“1” or “H” to DCDC 110. Consequently, DCDC 110 makes a transition to PSM.

[2] The case of DDPSM_LINK=“0” or “L” and LINK(i)_EN=“1” or “H” (i=1, 2, 3)

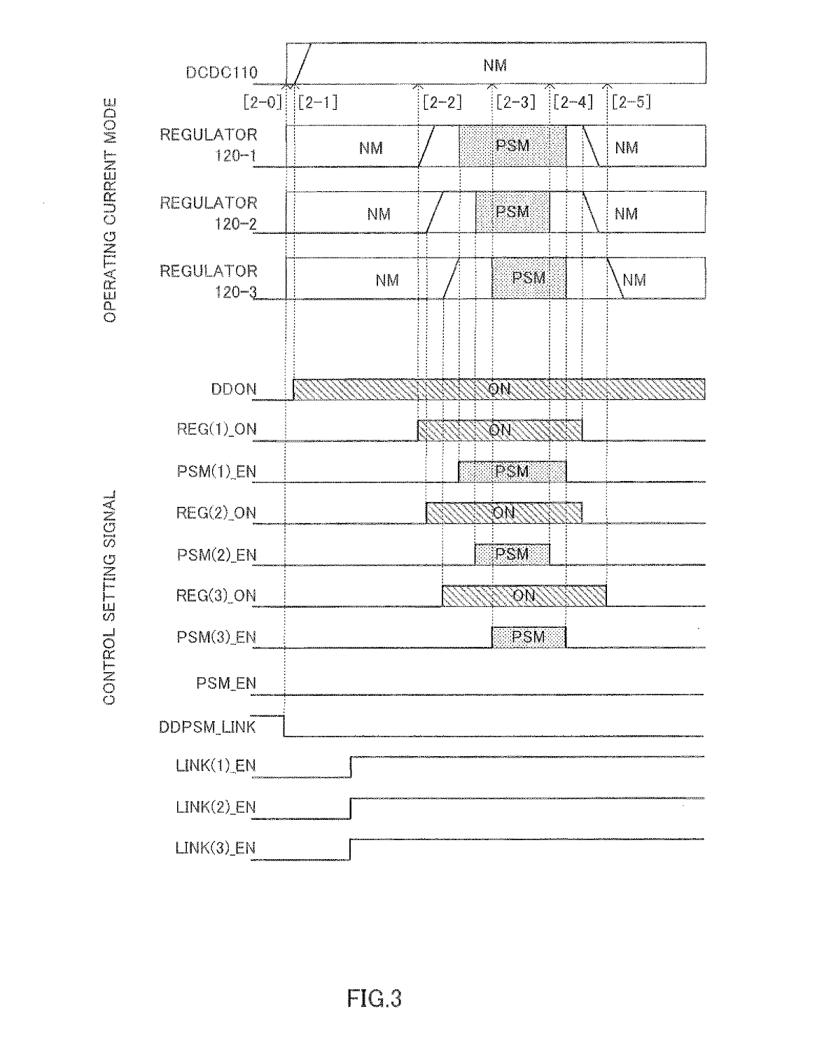

In this case, the ON/OFF state or the operating current mode of regulator 120-i (i=1, 2, 3) is not reflected on the operating current mode of DCDC 110. Description will be given with reference to FIG. 3.

[2-0]

When DDPSM_LINK=“0” or “L” is input to link control section 130 before and after DCDC 110 is started (before starting in the example of FIG. 3), link control section 130 does not reflect the ON/OFF state or the operating current mode of each regulator 120-i (i=1, 2, 3) on the operating current mode of DCDC 110 but outputs PSM_EN=“0” or “L” to DCDC 110 even if LINK(i)_EN=“1” or “H” (i=1, 2, 3) is input. Consequently, DCDC 110 is brought into NM. Accordingly, the operating current mode of DCDC 110 is subsequently maintained in NM irrespective of the ON/OFF state or the operating current mode of each regulator 120-i (i=1, 2, 3).

[3] The case of DDPSM_LINK=“1” or “H”, LINK(1)_EN=“0” or “L”, and LINK(i)_EN=“1” or “H” (i=2, 3)

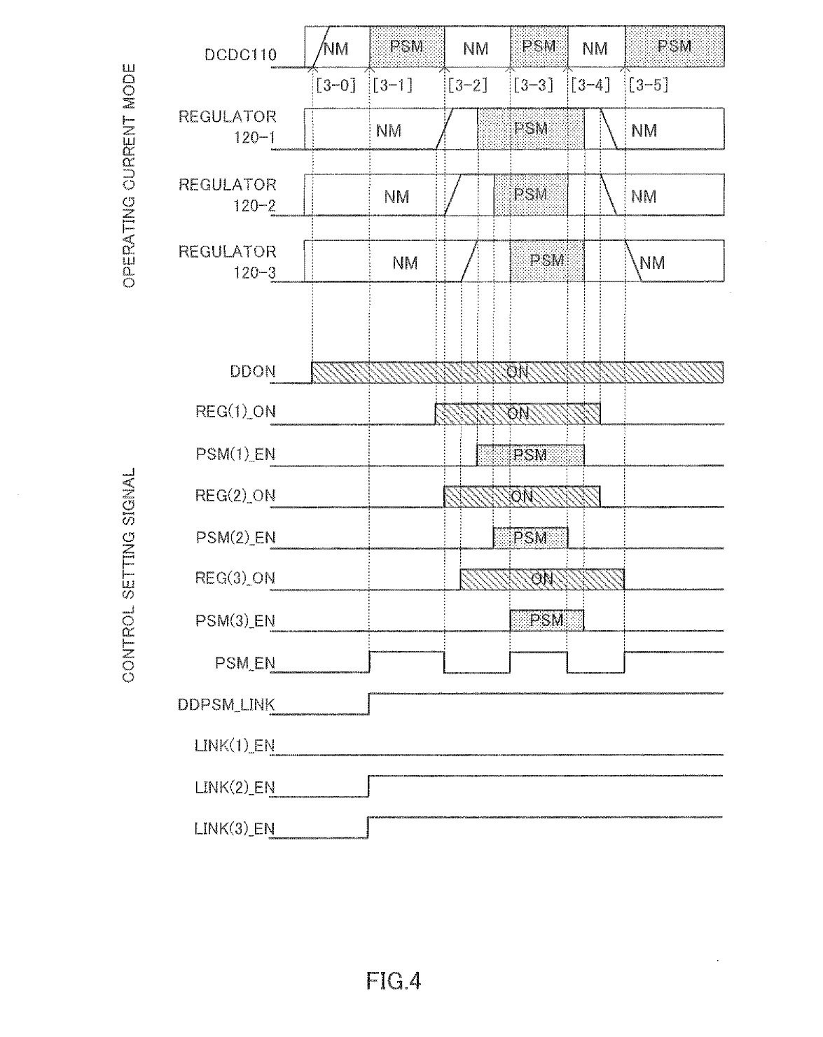

In this case, the ON/OFF state or the operating current mode of regulator 120-1 is not reflected on the operating current mode of DCDC 110 but the ON/OFF state or the operating current mode of regulator 120-i (i=2, 3) is reflected on the operating current mode of DCDC 110. Description will be given with reference to FIG. 4.

[3-0]

When DDON=“1” or “H” is input to DCDC 110, DCDC 110 is started.

[3-1]

Before and after DCDC 110 is started (after starting in the example of FIG. 4), DDPSM_LINK=“1” or “H”, LINK(1)_EN=“0” or “1” and LINK(i)_EN=“1” or “H” (i=2, 3) are input to link control section 130. All of regulators 120-i (i=2, 3) to be the link destination of DCDC 110 having LINK(i)_EN=“1” or “H” are set into the OFF state. Therefore, link control section 130 outputs PSM_EN=“1” or “H” to DCDC 110. Consequently, DCDC 110 makes a transition to PSM.

[3-2]

When regulator starting signal REG(2)_ON=“1” or “H” is input to regulator 120-2, regulator 120-2 is started (ON) in NM. When regulator 120-2 having LINK(2)_EN=“1” or “H” is turned ON, link control section 130 outputs PSM_EN=“0” or “L” to DCDC 110. Consequently, DCDC 110 makes a transition to NM.

[3-3]

When all of regulators 120-2 and 120-3 having LINK(i)_EN=“1” or “H” make a transition to PSM, link control section 130 outputs PSM_EN=“1” or “H” to DCDC 110. Consequently, DCDC 110 makes a transition to PSM.

[3-4]

When regulator 120-2 having LINK(2)_EN=“1” or “H” makes a transition from PSM to NM, link control section 130 outputs PSM_EN=“0” or “L” to DCDC 110. Consequently, DCDC 110 makes a transition from PSM to NM.

[3-5]

All of regulators 120-2 and 120-3 having LINK(i)_EN=“1” or “H” which are the link destination of DCDC 110 are turned OFF. Therefore, link control section 130 outputs PSM_EN=“1” or “H” to DCDC 110. Consequently, DCDC 110 makes a transition to PSM.

As described above, according to the embodiment, DCDC 110 and each regulator 120-i (i=1, 2, 3) have the normal mode and the low consumption mode as the operating current mode, and link control section 130 switches the operating current mode of DCDC 110 depending on the ON/OFF state of regulator 120-i or the operating current mode of regulator 120-i. Consequently, it is possible to reduce power consumption while reducing a complicated CPU control through CPU/peripheral LSI 200.

Moreover, link control section 130 switches the operating current mode of DCDC 110 into the low power consumption mode when all of regulators 120-i (i=1, 2, 3) are turned OFF. Consequently, it is possible to decrease the power consumption of power supply system 100.

Furthermore, link control section 130 switches the operating current mode of DCDC 110 into the normal mode when any of regulators 120-i (i=1, 2, 3) is turned ON. Consequently, a source voltage having an excellent loading capability and transient response characteristic is supplied to the regulator turned ON.

In addition, link control section 130 switches the operating current mode of DCDC 110 into the low current consumption mode when all of regulators 120-i (i=1, 2, 3) are turned ON and all of the operating current modes of regulator 120-i are changed into the low current consumption mode. Consequently, it is possible to decrease the power consumption of power supply system 100.

Moreover, link control section 130 switches the operating current mode of DCDC 110 into the normal mode when one of the operating current modes of regulator 120-i (i=1, 2, 3) is changed into the normal mode if the operating current mode of DCDC 110 is set into the low current consumption mode. Consequently, a source voltage having an excellent transient response characteristic is supplied to the regulator which is brought into the normal mode.

Furthermore, link control section 130 receives as input control signal DDPSM_LINK indicating whether or not the operating current mode of DCDC 110 is to be switched depending on the ON/OFF state of at least one of regulators 120-i (i=1, 2, 3) or the operating current mode of the regulator, and switches the operating current mode of DCDC 110 depending on the ON/OFF state of the regulator or the operating current mode of the regulator if control signal DDPSM_LINK indicates a switching command. In addition, link control section 130 receives as input a specifying signal for specifying the regulator to be used for switching the operating current mode of DCDC 110, and switches the operating current mode of DCDC 110 depending on the ON/OFF state of the regulator specified by the specifying signal or the operating current mode of the regulator. Consequently, it is possible to enhance a general purpose when the number of the regulators is increased.

### Embodiment 2

In Embodiment 1, the description has been given to the power supply system and the power supply method which can reduce power consumption while reducing the CPU control also in the case in which the power supply system includes the plurality of regulators.

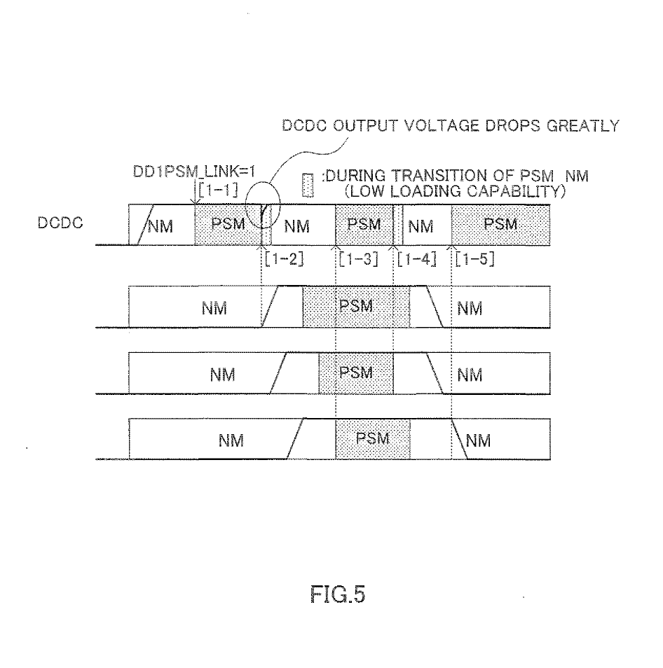

In some cases, the regulator is started so that a source voltage output from the DCDC drops while the DCDC makes a transition from PSM to NM. For example, as shown in FIG. 5, a DCDC output voltage drops in [1-2] when regulator 120-1 is started in [1-2].

In the embodiment, therefore, regulator starting signal REG(i)_ON (i=1, 2, 3) is delayed and a control is carried out in such a manner that regulator 120-i is not immediately started even if REG(i)_ON=“1” or “H” is brought. Consequently, it is possible to avoid the drop in the DCDC output voltage due to the starting operation of the regulator.

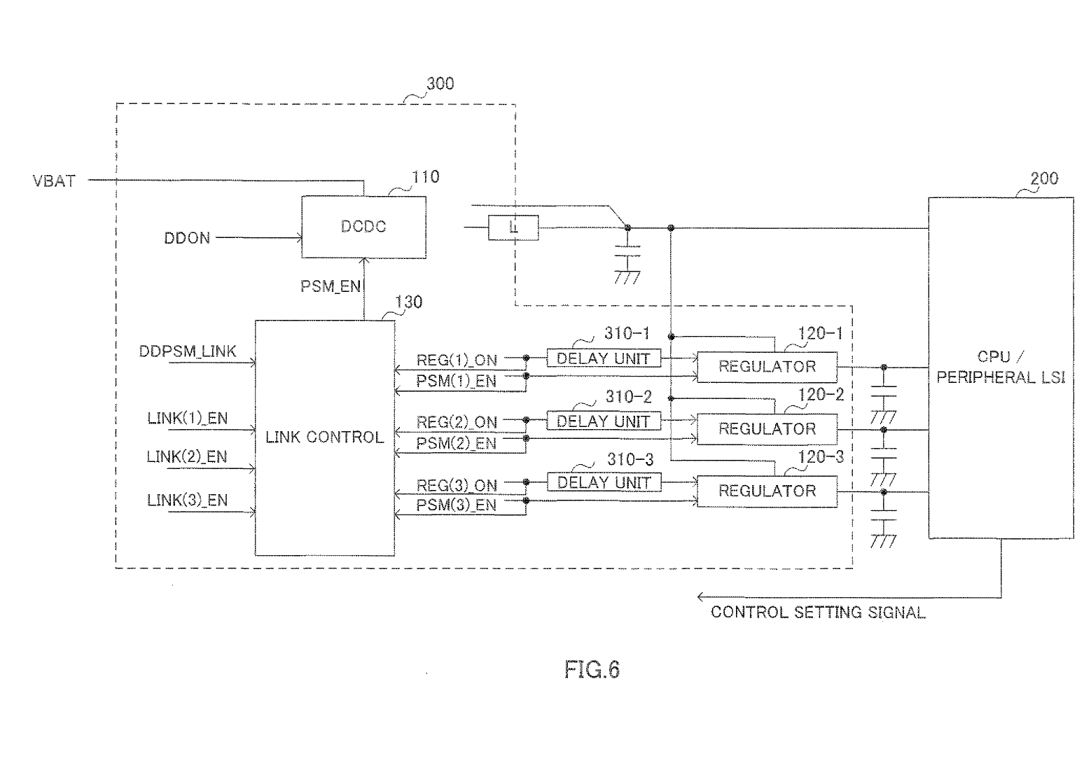

FIG. 6 is a block diagram showing a structure of a main part in a power supply system according to the embodiment. In the power supply system according to the embodiment of FIG. 6, common components to those in FIG. 1 have the same reference numerals and description thereof will be omitted. In power supply system 300 of FIG. 6, delay unit 310-i (i=1, 2, 3) for delaying regulator starting signal REG(i)_ON (i=1, 2, 3) is provided in a former stage of each regulator 120-i (i=1, 2, 3) in contrast with power supply system 100 in FIG. 1.

Delay unit 310-i (i=1, 2, 3) delays, by predetermined time Td rearward, a rise timing making a transition from “0” or “L” to “1” or “H” of regulator starting signal REG(i)_ON.

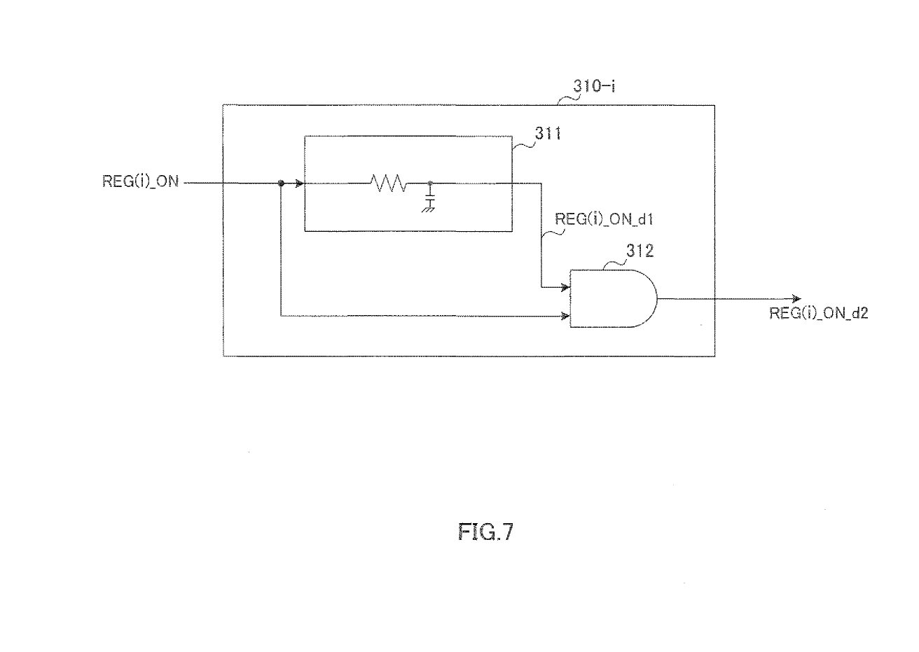

FIG. 7 is a diagram showing an example of a circuit structure of the delay unit 310-i (i=1, 2, 3). Each delay unit 310-i is constituted by delay unit 311 and AND circuit 312, for instance.

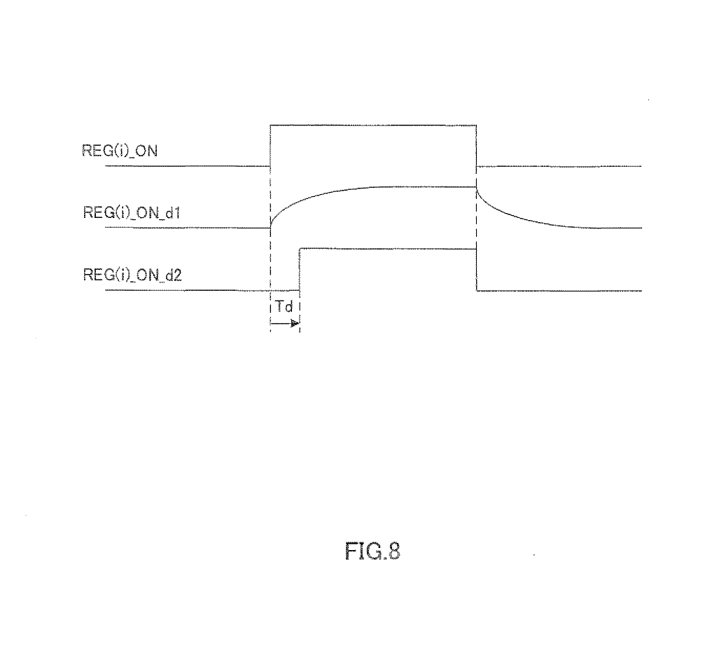

FIG. 8 is a diagram showing an input/output relationship of the delay unit 310-i (i=1, 2, 3). As is apparent from FIG. 8, a rise timing of signal. REG(i)_ON_d2 output from delay unit 310-i (i=1, 2, 3) is delayed rearward by predetermined time Td through delay unit 310-i (i=1, 2, 3) with respect to the rise timing of regulator starting signal REG(i)_ON input to delay unit 310-i. On the other hand, a fall timing of signal REG(i)_ON_d2 output from delay unit 310-i (i=1, 2, 3) is not delayed by delay unit 310-i but is coincident with the fall timing of regulator starting signal REG(i)_ON input to the delay unit 310-i.

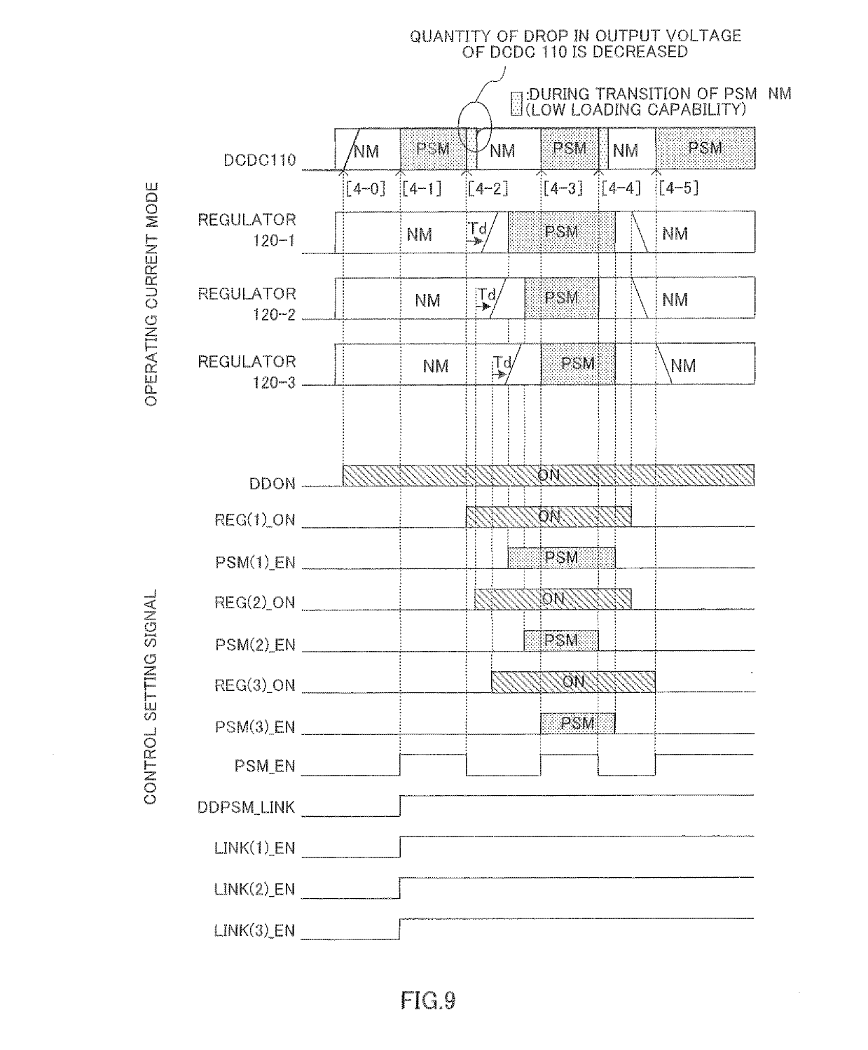

A method of controlling an operating current mode of DCDC 110 according to the embodiment will be described with reference to FIG. 9.

FIG. 9 is a diagram showing a relationship between a transition of the operating current mode of DCDC 110 and each regulator 120-i (i=1, 2, 3) and each control setting signal. FIG. 9 shows, as the control setting signal, DCDC starting signal DDON, regulator starting signal REG(i)_ON (i=1, 2, 3), mode switching signal PSM(i)_EN, mode switching signal PSM_EN, control signal DDPSM_LINK and specifying signal LINK(i)_EN.

FIG. 9 shows an example of the case of DDPSM_LINK=“1” or “H” and LINK(i)_EN=“1” or “H” (i=1, 2, 3).

As shown in FIG. 9, each regulator 120-i (i=1, 2, 3) is started after a passage of predetermined time Td since regulator starting signal REG(i)_ON makes a transition from “0” or “L” to “1” or “H”. Predetermined time Td is set in such a manner that DCDC 110 ends to make a transition to NM and each regulator 120-i (i=1, 2, 3) is then started, and a start timing of each regulator 120-i (i=1, 2, 3) is delayed by predetermined time Td. Consequently, it is possible to reduce a quantity of the drop in the output voltage of DCDC 110.

As described above, in the embodiment, delay unit 310-i is provided in the former stage of each regulator 120-i (i=1, 2, 3) and is caused to delay the start timing of each regulator 120-i.

Delay unit 310-i delays the start timing of each regulator 120-i by predetermined time Td in such a manner that DCDC 110 is started to complete a transition from a low power consumption mode to a normal mode and each regulator 120-i (i=1, 2, 3) is then started. Consequently, it is possible to reduce the quantity of the drop in the output voltage of DCDC 110.

The DCDC (DC/DC converter) designates a circuit for converting a voltage value of a certain DC current into a different voltage value through a switching mechanism.

The regulator designates a linear regulator and is a circuit for continuously controlling a magnitude of a power output from an input to a load, thereby converting a voltage value of a certain DC power supply into a smaller voltage value.

Moreover, an ON state of the regulator indicates a state in which the output voltage of the regulator reaches a desirable value so that a current can be supplied to a load, that is, a state in which there is operated a circuit for continuously controlling a power to be transmitted from the input of the regulator to the load and converting a voltage value of a certain DC power supply into a smaller voltage value.

Furthermore, an OFF state of the regulator indicates a state in which the output voltage of the regulator has a desirable value or less (for example, 0 V) and a necessary current cannot be supplied or is not supplied to the load.

The disclosure of Japanese Patent Application No. 2009-066657, filed on Mar. 18, 2009, including the specification, drawings and abstract, is incorporated herein by reference in its entirety.

### INDUSTRIAL APPLICABILITY

The present invention is useful as a power supply system and a power supply method which can reduce power consumption while reducing a CPU control and supply a stable DC voltage to various electronic apparatuses also in the case in which the power supply system includes a plurality of regulators.

### REFERENCE SIGNS LIST

100, 300 Power supply system

110 DCDC (DC/DC converter)

120-1, 120-2, 120-3 Regulator

130 Link control section

200 CPU/peripheral LSI

310-1, 310-2, 310-3 Delay unit

311 Delay unit

312 AND circuit

1. A power supply system comprising:
a direct current to direct current converter having, as an operating current mode, a normal mode, and a low power consumption mode in which an operation is carried out with a lower power consumption than in the normal mode;
a plurality of regulators having, as an operating current mode, a normal mode, and a low power consumption mode in which an operation is carried out with a lower power consumption than in the normal mode and setting an output from the direct current to direct current converter as a source voltage; and
a control section that switches the operating current mode of the direct current to direct current converter depending on an on/off state of the plurality of regulators or the operating current mode of the plurality of regulators.

2. The power supply system according to claim 1, wherein the control section switches the operating current mode of the direct current to direct current converter into the low power consumption mode when all of the plurality of regulators are turned off.

3. The power supply system according to claim 1, wherein the control section switches the operating current mode of the direct current to direct current converter into the normal mode when one of the plurality of regulators is turned on.

4. The power supply system according to claim 1, wherein the control section switches the operating current mode of the direct current to direct current converter into the low current consumption mode when all of the plurality of regulators are turned on and all of the operating current modes of the plurality of regulators are changed into the low current consumption mode.

5. The power supply system according to claim 1, wherein the control section switches the operating current mode of the direct current to direct current converter into the normal mode when one of the operating current modes of the plurality of regulators is changed into the normal mode if the operating current mode of the direct current to direct current converter is the low current consumption mode.

6. The power supply system according to claim 1, wherein the control section receives as input a control signal indicating whether or not the operating current mode of the direct current to direct current converter is to be switched depending on the on/off state of at least one of the plurality of regulators or the operating current mode of the regulator, and switches the operating current mode of the direct current to direct current converter depending on the on/off state of the regulator or the operating current mode of the regulator when the control signal indicates a switching command.

7. The power supply system according to claim 1, wherein the control section receives as input a specifying signal for specifying the regulator to be used for switching the operating current mode of the direct current to direct current converter, and switches the operating current mode of the direct current to direct current converter depending on the on/off state of the regulator specified by the specifying signal or the operating current mode of the regulator.

8. The power supply system according to claim 1, further comprising a delay setting section that delays a starting signal for switching the on/off state of the regulator in a former stage of the regulator.

9. A power supply method in a power supply system including a direct current to direct current converter having, as an operating current mode, a normal mode, and a low power consumption mode in which an operation is carried out with a lower power consumption than in the normal mode, and a plurality of regulators having, as an operating current mode, a normal mode, and a low power consumption mode in which an operation is carried out with a lower power consumption than in the normal mode and setting an output from the direct current to direct current converter as a source voltage, the method comprising:
switching the operating current mode of the direct current to direct current converter depending on an on/off state of the plurality of regulators or the operating current mode of the plurality of regulators.
